(19) United States
(12) Patent Application Publication
(10) Pub. No.: US 2005/0275902 A1
(43) Pub. Date: Dec. 15, 2005

(54) Recording medium, information terminal device, and image print system

(75) Inventors: Noboru Koyama, Kawagoe-shi (JP); Masahito Niikawa, Tokyo (JP); Ayako Doi, Osaka (JP); Tatsuya Sasazawa, Yokohama-shi (JP); Akiko Murayama, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Photo Imaging, Inc.

(21) Appl. No.: 11/128,521

(22) Filed: May 13, 2005

(30) Foreign Application Priority Data
May 25, 2004 (JP) JP2004-155232
Jul. 2, 2004 (JP) JP2004-196797
Jul. 23, 2004 (JP) JP2004-215113

(51) Int. Cl. H04N 1/00

(52) U.S. Cl. 358/401

(57) ABSTRACT

A recording medium including: an image storing medium for storing an image information; and a display section installed on a surface of said image storing medium, wherein said display section includes a radio IC chip.

This application is based on Japanese Patent Application No. 2004-155232 filed on May 25, 2004, 2004-196797 filed on Jul. 2, 2004, and 2004-215113 filed on Jul. 23, 2004, in Japanese Patent Office, the entire content of which is hereby incorporated by reference.

### TECHNICAL FIELD

The present invention relates to a recording medium having at least an image storing medium for storing image information and a radio IC chip, an information terminal device for printing the image information stored in the image storing medium, and an image print system using the information terminal device.

### BACKGROUND

In correspondence with the spread of digital cameras, printing image information in an image storing medium is increased. Printing image information stored in the image storing medium is performed via conventional photo studios and moreover, a method of the so-called self print type using an information terminal device installed in convenience stores and mass-sale stores is widespread.

In printing by the self print method, simplification of settlement of accounts is required, and prior an art (refer to Japanese Patent Application 2002-109631) for giving a prepaid card function to the image storing medium is proposed, though in the present circumstances, a method for inserting a charge into the information terminal device by a user is most general.

In the above prior art, since the image storage medium and the prepaid card are united as cards, the operativity of printing improves.

However, since settlement-of-accounts information is stored in an image storage medium, the trouble exists in the viewpoint of security.

Therefore, making an image storage medium and the radio IC chip which is another information storage media unite is proposed (see JP-A No. 2002-354384).

However, the IC chip part of the image storage medium currently disclosed by the above prior art does not have the display function.

So, it is difficult to identify the image storage mediums.

Furthermore, since the image storage medium and the radio IC chip have adhered strongly, it is impossible to exchange the IC chip according to specification alternation of an IC chip.

Moreover, according to the above prior art, it is disclosed that settlement of a printing charge is possible by using the image storage medium which has an IC chip.

However, suitable settlement-of-accounts timing is not disclosed in the above prior art.

Furthermore, in the printing by the self print method, the problem of forgetting for a user to extract an image storage medium may occur.

In the prior art, in spite of attaching the IC chip to the image storage medium, measures on a problem are not taken.

### SUMMARY

One side of the present invention is a recording medium including: an image storing medium for storing an image information; and a display section installed on a surface of said image storing medium, wherein said display section includes a radio IC chip.

Further, one side of the present invention is an information terminal device including: a print designation operation section for conducting an image print designation operation, a medium loading section for loading an image storing medium; a medium reading section for reading image information stored in said image storing medium, a reader-writer section for receiving information stored in a radio IC chip and transmitting information from said information terminal device, and a control section for updating information of settlement of accounts received from said radio IC chip on the basis of information generated according to said print designation operation and for transmitting said updated information of settlement of accounts to said radio IC chip by said reader-writer section.

Furthermore, one side of the present invention is an image print system including:
an image storing medium containing image information; a radio IC chip containing information other than said image information;
an information terminal device including a medium loading section for loading said image storing medium, a medium reading section for reading image information stored in said image storing medium, a print designation operation section for performing an image print designation operation on the basis of said read image information, a reader-writer section for receiving information stored in said radio IC chip and transmitting information from said information terminal device, and a transmitter for transmitting information to an outside of said information terminal device, and a control section for controlling said print designation operation section, said medium loading section, said medium reading section, and said reader-writer section; and
a detection section for detecting existence of said radio IC chip in said operation area of said information terminal; and
a detection information transmission section for transmitting said detection information obtained by said detector to said information terminal,
wherein said control section, when said image storing medium is loaded in said medium loading section and no existence of said radio IC chip in said operation area is detected on the basis of said detection information, generates a warning signal.

### BRIEF DESCRIPTION OF THE DRAWINGS

FIG. 1 is a schematic perspective view showing an embodiment of the information terminal device of the present invention.

FIG. 2 is a block diagram showing an embodiment of the information terminal device of the present invention.

FIG. 3 is a flow chart for explaining an embodiment of the information terminal device of the present invention.

FIG. 4 is a flow chart for explaining an embodiment of the information terminal device of the present invention.

FIG. 5 is a layout drawing showing an embodiment of a store to which the image print system of the present invention is applied.

FIG. 6 is a front view showing an embodiment of the image storing medium relating to the present invention.

FIG. 7 is a front view showing an embodiment of a radio IC chip having a display section.

FIG. 8 is a schematic enlarged cross sectional view of FIG. 7.

FIG. 9 is a rear view showing another embodiment of the radio IC chip having a display section.

FIG. 10 is a schematic enlarged cross sectional view of FIG. 9.

FIG. 11 is a schematic enlarged cross sectional view showing still another embodiment of the radio IC chip having a display section.

FIG. 12 is a front view showing another embodiment of the display section.

FIG. 13 is a flow chart showing the flow of the print designation operation of the information terminal device of the present invention.

FIG. 14 is an illustration showing an embodiment of a user data base.

FIG. 15 is a front view showing an embodiment of the screen section and medium reading section when the operation is started.

FIG. 16 is an illustration showing an embodiment (simple setting) of a user interface of the screen section.

FIG. 17 is an illustration showing an embodiment (detailed setting) of the user interface of the screen section.

### DESCRIPTION OF THE PREFERRED EMBODIMENTS

Hereinafter, an example of the preferred embodiments for executing the present invention will be explained with reference to the accompanying drawings. However the scope of this invention is not limited by the embodiments following.

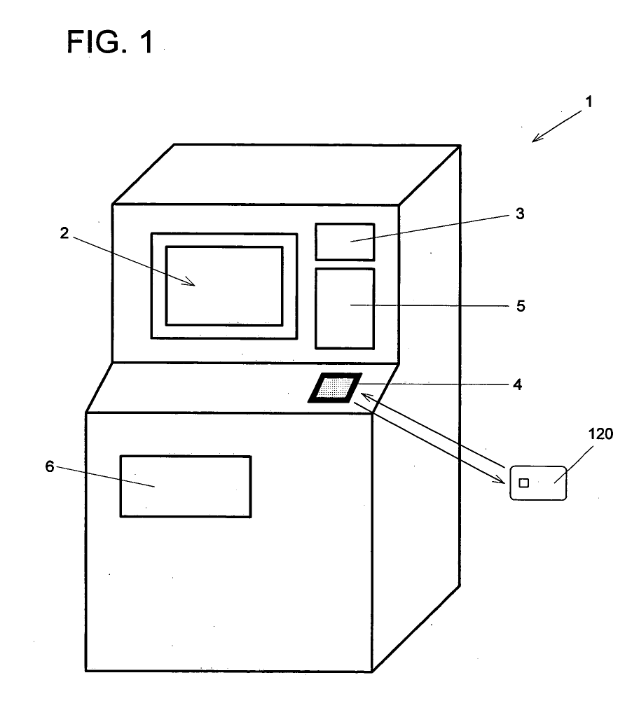

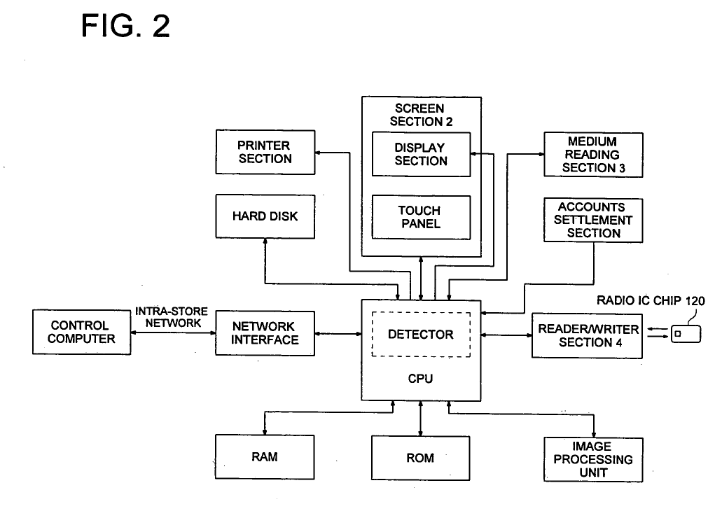

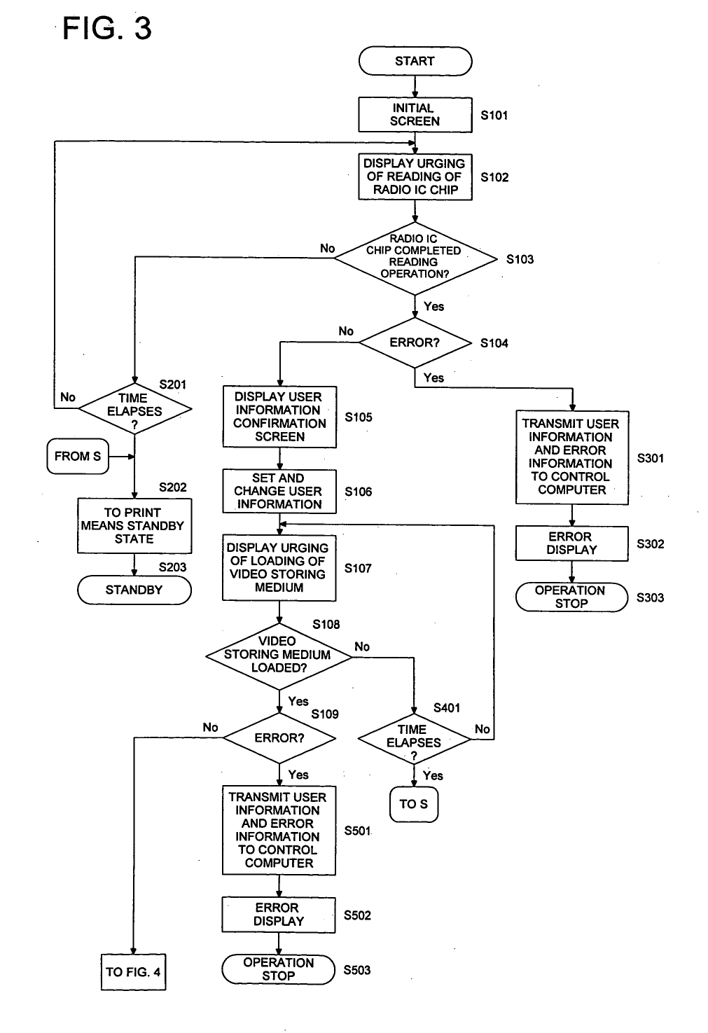

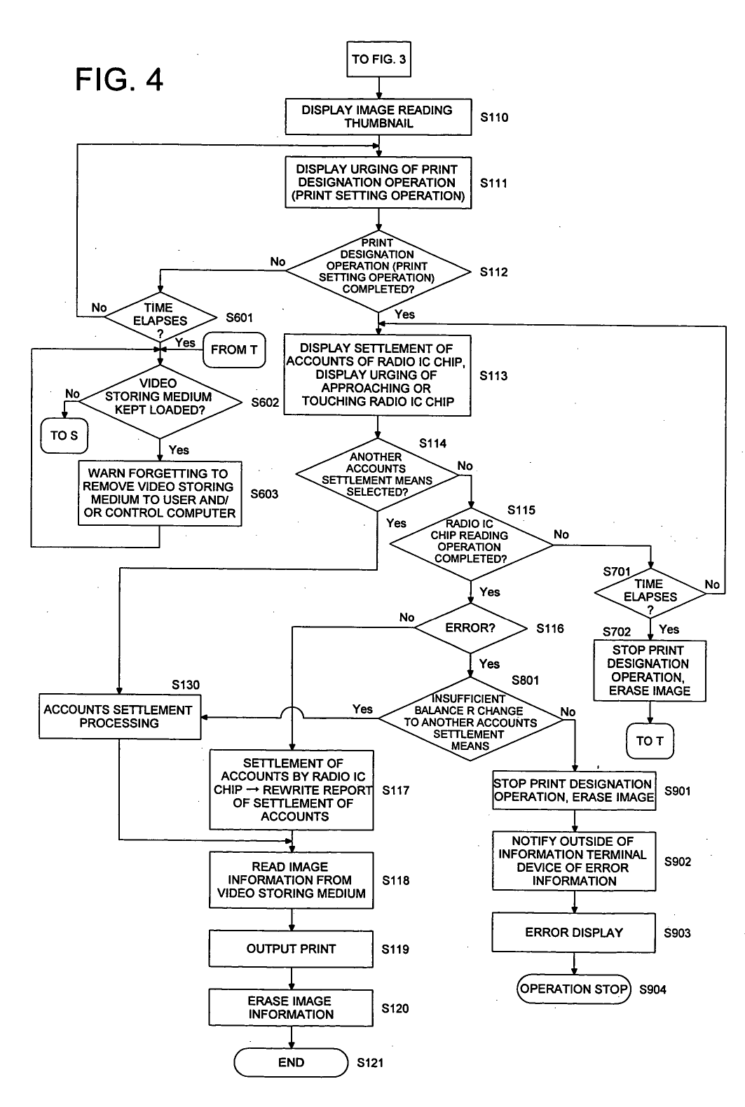

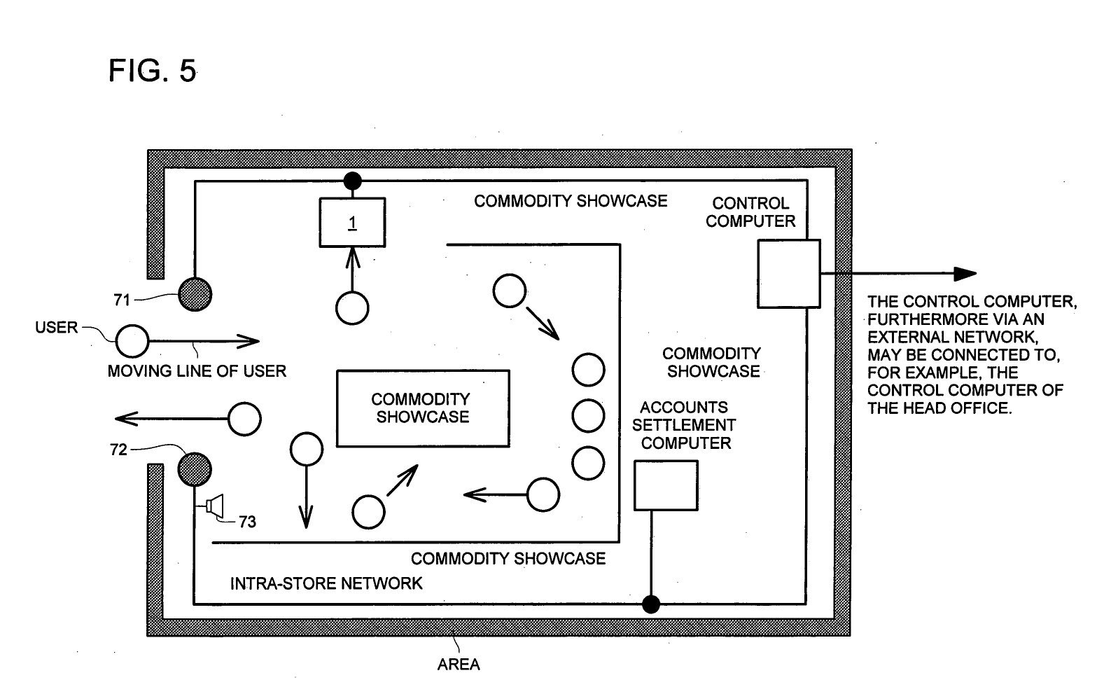

FIG. 1 is a schematic perspective view showing an embodiment of the information terminal device of the present invention, FIG. 2 is a block diagram showing an embodiment of the control system of the information terminal device of the present invention, FIGS. 3 and 4 are flow chart for explaining an embodiment of the information terminal device of the present invention, and FIG. 5 is a layout drawing showing an embodiment of a store to which the image print system of the present invention is applied.

An information terminal device 1 shown in FIG. 1 is a device for performing a print designation operation of an image stored in an image storing medium, carried by a user, capable of at least storing or rewriting and performing settlement of accounts of the print designation operation together with the image storing medium on the basis of information of settlement of accounts stored in a radio IC chip 120 carried by him and is structured so as to rewrite the information of settlement of accounts in the radio IC chip 120 according to the print designation operation.

In FIG. 1, the information terminal device 1 is composed of a screen section 2 which is a display section for explaining and displaying various operation contents and image information confirmation and a touch panel section (in this invention, functions as a print designation operation section) for performing various operations, a medium reading section 3 (in this invention, functions as a medium loading section and a medium reading section) in which an image storing medium carried by a user is loaded for the print designation operation, a reader/writer section 4 for transmitting and receiving data from the radio IC chip 120 and reading and writing various information, a bending section 5 for settlement of accounts by other than the radio IC chip 120, and a print takeout port 6. Additionally, various control means such as the image reading means, image editing means, and printing means can be applied.

In the information terminal device 1, as shown in FIG. 2, by the CPU (in the present invention, functions as a control section), the functions of the screen section 2 (display section, touch panel), the medium reading section 3, the reader/writer section 4 for transmitting and receiving data from the radio IC chip 120, an accounts settlement section for settling accounts by the radio IC chip 120 and settling accounts by the payment means other than the radio IC chip 120 from the bending section 5, a printer section which is a hard disk and a printing means, and an image processing section for reading images from the RAM, ROM, and image storing medium and performing various setting processes for images read by the print designation operation are controlled and by a control computer networked outside the information terminal device 1 via a network interface, the functions and information are controlled. Further, the printing means may be structured so as to print by an external printer via the network.

A part of control section is working through a reader/writer section 4 transmitting and receiving to radio IC chip 120 as the detection section which detects periodically radio IC chip 120 which exists in the operation area of this information terminal.

Further, “operation area” in this specification is substantially referred to as a range within which the information terminal device 1 can be operated.

The radio IC chip 120 used in the present embodiment will be explained below. Further, in addition to calling of “radio IC chip”, there are various calling ways available such as “radio chip”, “non-contact IC chip”, “IC tag”, “radio tag”, “RFID tag”, or “non-contact IC card”. In the present invention, any of them is acceptable.

In the present invention, the radio IC chip may have a structure of a double-sided electrode instead of a single-sided electrode and concretely, V720-b52P01, V720-D52P02, V720-D52P03, and V720-D52P04 manufactured by Omron, Ltd., “μ chip” having a loaded IC manufactured by Hitachi, Ltd., “T-junction” manufactured by Toppan Printing Co., Ltd., and “e-TRON/16-AE45X” joint-developed by YRP Ubiquitous Network Working Laboratory, Tokyo University, Sakamura Laboratory, and Renaissance Technology may be cited.

For example, “μ chip” mentioned above is a ROM chip 0.4 mm square, and a high frequency analog circuit of 1.45 GHz and a 128-bit ROM are integrated to this size, and the thickness thereof is only 0.06 mm.

The μchip is pursued to make it smaller, so that the function thereof is restricted and it is a ROM type which only reads, though a general radio IC chip is of a RAM type which is rewritable.

As a radio IC chip 120, there are a rewritable RAM type and an only reading ROM type available and the present embodiment adopts the RAM type which can rewrite information of settlement of accounts.

Information stored in the radio IC chip 120 includes the identification of the radio IC chip 120, user information (name, age, address, communication destination, email address, etc.), and information of settlement of accounts (deposition balance, purchase point cumulative value, etc.). The purchase of the radio IC chip 120 and the account to be deposited in the radio IC chip 120 can respond to a store where the information terminal device is installed or a controlling enterprise or respond to a constitution of giving a money receiving function to the information terminal device.

In addition, it can store the information about an image and the information about a user (for example, photographing condition of an image, photographing location, photographing date, content of photographing, picture taker name, the number of print of each image, print size, etc. user's name, age, address, contact, etc.).

By making such information store, the time and effort which is generated when an address and a name, a required number of sheets, size, etc. are inputted and wrote at the each time of printing and requesting to print, can be saved.

The radio IC chip 120 of the present embodiment is preferably loaded on a card-shaped one suited to carry and as a card-shaped one, for example, a visiting card type, a credit card type, and an ID card type hung from the neck by a neck strap may be cited.

As an image storing medium used in the present invention which can be at least stored or rewritten, there is a memory card standardized like an SD card and in addition to the SD card, there is a memory card using a flash memory as a storing medium represented by the mini SD card, memory stick, memory stick PRO, memory stick DUO, compact flash, microdrive, xD picture card, and smartMedia.

Further, the image storing medium and radio IC chip used in the information terminal device of the present invention may be a storing medium in which the two are formed integrally or the two may be separately formed and carried. Particularly in a memory built-in digital camera, the camera itself serves as an image storing medium, so that the image storing medium and radio IC chip must be separately carried.

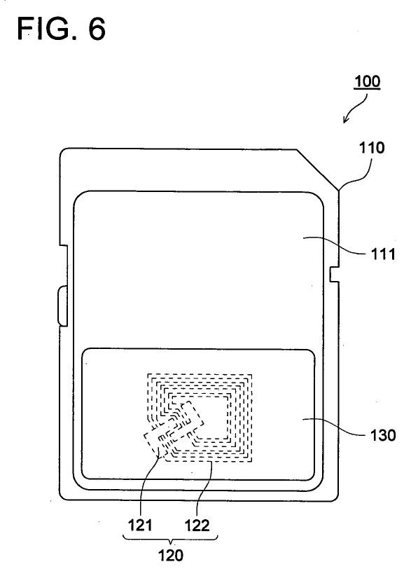

Here, a recording medium in which the image storing medium and radio IC chip are formed integrally will be explained by referring to FIGS. 6 to 12.

Hereinafter, an example of the preferred embodiments for executing the present invention will be explained with reference to the accompanying drawings.

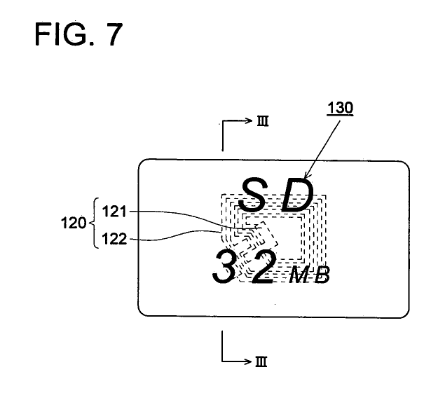

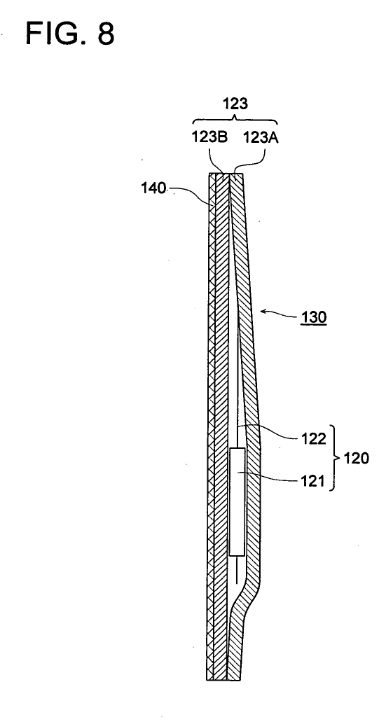

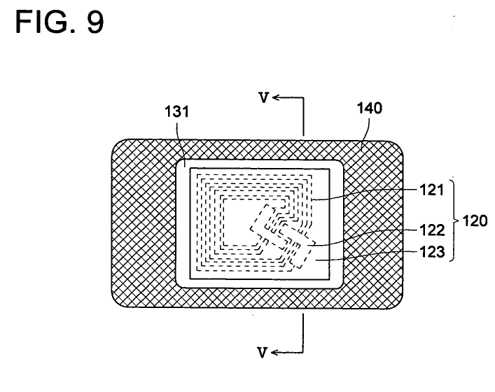

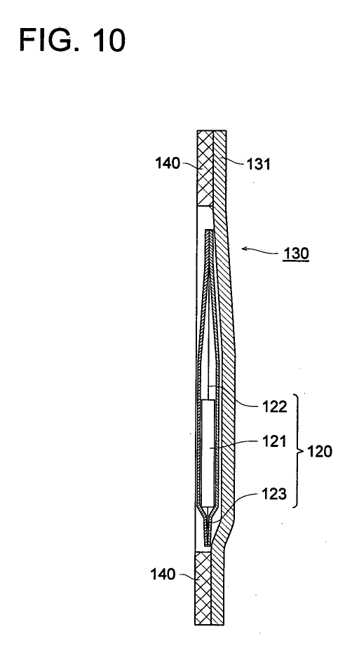

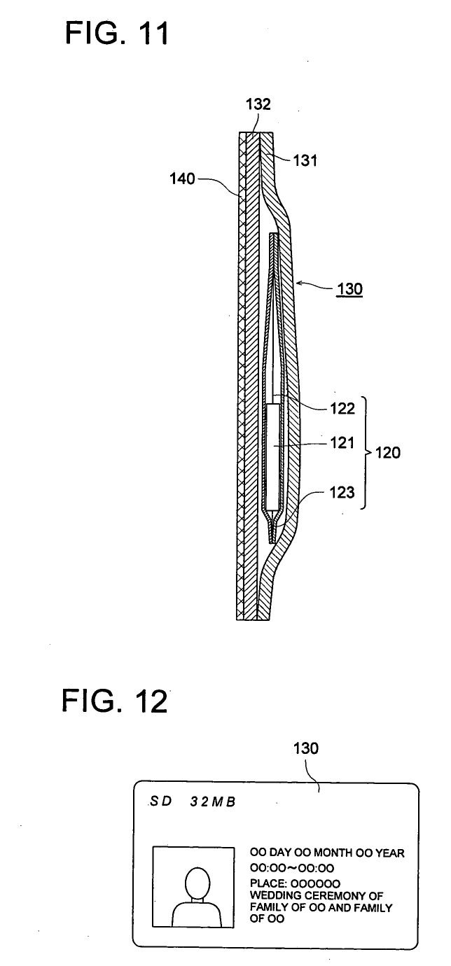

FIG. 6 is a front view showing an embodiment of the image storing medium relating to the present invention, and FIG. 7 is a front view showing an embodiment of the radio IC chip having a display section, and FIG. 8 is a schematic enlarged cross sectional view of FIG. 7, and FIG. 9 is a rear view showing another embodiment of the radio IC chip having a display section, and FIG. 10 is a schematic enlarged cross sectional view of FIG. 9, and FIG. 11 is a schematic enlarged cross sectional view showing still another embodiment of the radio IC chip having a display section, and FIG. 12 is a front view showing another embodiment of the display section.

As shown in FIG. 6, a recording medium 100 has the aforementioned radio IC chip 120 including an image storing medium 110 which can at least store and rewrite data and a display section 130.

The radio IC chip 120 having the display section 130 is installed at least on one of the surface and back of the body of the image storing medium 110, preferably on the surface (in this example, the side where no external contact is installed) like this embodiment and it can be exchanged. The exchange is performed by separating or removing it from the image storing medium 110 and then adhering or attaching a new radio IC chip 120 or a different radio IC chip 120.

Further, the radio IC chip 120 is mainly composed of an IC chip section 121 and an antenna section 122 (refer to the dotted lines shown in FIGS. 6 and 7). The portion mainly composed of the IC chip section 121 and the antenna section 122 is referred to as an IC module in the present embodiment.

As shown in FIG. 8, on a surface side 123A (in the present invention, functions as a first base member) of a base 123 of the concerned radio IC chip, a display section 130 using a recording means including printing and ink jet is installed.

On the display section 130, data concerning the body itself of the image storing medium 110, that is, the kind of the image storing medium, storage capacity, and manufacture data (manufacturer's name, product number, etc.) are displayed. Further, the display section 130 may be rewritable or unrewritable or may be partially rewritable or unrewritable.

On a back side 123B (in the present invention, functions as a second base member) of the base 123, an adhesive layer or a self-adhesive layer 140 (in the present invention, functions as an adhesive layer) is installed and by the adhesive layer or the self-adhesive layer 140, the radio IC chip 120 is installed on the image storing medium 110.

As an adhesive or a self-adhesive used for the adhesive layer or the self-adhesive layer 140, known and public adhesives used for the adhesive means or the self-adhesive means for the display section of this kind of image storing medium may be cited. Further, at the time of separation of the radio IC chip 120 when exchanging it, the adhesive layer or the self-adhesive layer 140 which can be separated easily, can be adhered or self-adhered again after separation, may be destroyed, and may loose its adhesive force or self-adhesive force are all included in the present invention.

In the standardized image storing medium 110, a concavity space 111 (in the present invention, functions as a concavity) for self-adhering a display seal for displaying the produce name, manufacturer's name, or information of a user (date, recording contents, responsible person's name, etc.) is standardized in length, width, and depth or is formed in a fixed size (for example, in an example of the SD card, 13.8 mm in length, 21 mm in width, and 0.075 mm in depth). In the present embodiment, using the concave space 111 for self-adhering the display seal which is standardized and prepared beforehand, the radio IC chip 120 having the display section 130 is installed exchangeably on the concave space 111, nevertheless the general-purpose properties of the image storing medium are not impaired.

Furthermore, when radio IC chip 120 is installed in standardized concave space 111, it is preferable that the thickness of radio IC chip 120 is the same as the depth of above-mentioned concave space 111, or less.

When various equipment is loaded with the image storage medium 110, as long as there is no possibility of being entrapped, there is no possibility of getting turned up, there is no possibility of separating, and there is no possibility of being torn and there is no effect in the ability of the image storage medium 110 at all, the thickness of radio IC chip 120 may be more than the depth of the concave space 111.

Furthermore, although it is preferable for the installation location of radio IC chip 120 to be the concave space 111, in case various equipment is loaded with the image storage medium 110, as long as there is no possibility of being entrapped, there is no possibility of getting turned up, there is no possibility of separating, and there is no possibility of being torn, the installation locations of radio IC chip 120 may be other place.

The radio IC chip 120 having the display section 130 is preferably installed, as mentioned above, via the adhesive layer or the self-adhesive layer 140 on the back 123B of the base 123 and in this case, as an adhesive or a self-adhesive of the adhesive layer or the self-adhesive layer 140, a one not affecting the IC chip section 121, the antenna section 122, and the base 123 of the radio IC chip 120 is used. Further, by a means other than the adhesive layer or the self-adhesive layer 140, for example, the radio IC chip may be installed by fitting or embedding in the concave space 111. Even if the fitting or embedding means is used, the installed radio IC chip 120, as mentioned above, can be exchanged, so that needless to say, it can be removed. Furthermore, the material of the base 123 is preferably plastics or paper little shielding the electric field.

When the image storing medium 110 is sold at a specific store or a specific photographing device or information device is used, in the radio IC chip 120, it is preferable to store customer information such as actual use results of print services and various history information or link with the customer control data base mutually or in one way.

When the radio IC chip 120 is given the prepaid function, settlement of accounts when printing image data stored in the image storing medium 110 can be performed on a cashless basis.

The radio IC chip 120, even if it is highly advanced such as realization of high capacity, miniaturization, and high reading and writing speed, can be exchanged. Namely, it can be upgraded. Further, when a memory card having no loaded radio IC chip 120 is newly purchased, when the radio IC chip 120 is re-adhered, the original information can be used.

In the radio IC chip 120 having the display section 130, as the aforementioned embodiment shown in FIG. 8, the display section 130 is installed on the surface 123A of the base 123 of the radio IC chip 120, though as shown in FIGS. 9 and 10, the display 130 may be installed on a display section base 131 different from the base 123 of the radio IC chip 120. In this constitution, the adhesive layer or the self-adhesive layer 140 is preferably installed on the back of the display section 123 in the peripheral part of the radio IC chip 120. In either case, a material free of failures by radio waves is used.

As shown in FIG. 11, a constitution that in addition to the display section base 131, a back base 132 is installed, and the radio IC chip 120 is held between the display section base 131 and the back base 132, and the adhesive layer or the self-adhesive layer 140 is installed on the back of the back base 132 may be used.

The display of the display section 130 may be not only the display concerning the body itself of the image storing medium 110 like in the aforementioned embodiment but also display other than the display concerning the body itself of the image storing medium for assisting confirmation of a person himself of a face photograph as shown in FIG. 12 or may be both of the display concerning the body itself of the image storing medium 110 and display other than the display concerning the body itself of the image storing medium 110.

As display other than the display concerning the body itself of the image storing medium 110, face photograph, classification file name of stored image (for example, classification of individual, company, belonging post, etc.), date, time, location, event (for example, sports meeting, wedding ceremony, etc.), and additionally mark of distributor or sales store, company name, and store name (OEM included) may be cited.

Further, a bar code is displayed, and a part of information (for example, product kind) stored in the radio IC chip 120 is displayed as a bar code, thus it can be read by various reading devices.

In the constitution that the print designation operation is performed for an image stored in the image storing medium, basically, an information terminal device having the known public self print type constitution is conventionally used. However, in the present embodiment, the radio IC chip 120 carried by a user is used for settlement of accounts of such a print designation operation and the information terminal device is added with a constitution of settling accounts, that is, a constitution of transmitting and receiving data from the radio IC chip 120 and reading and writing the information of settlement of accounts.

Hereinafter, the operating scheme of the information terminal device 1 of the present embodiment will be explained by referring to the flow charts shown in FIGS. 3 and 4.

Furthermore, this example has illustrated the case where charge settlement is performed using the card with which radio IC chip 120 was stuck, when printing the image stored by the image storage medium.

However, another storage medium with which radio IC chip 120 was stuck may perform charge settlement.

Firstly, a user carrying the radio IC chip 120 and image storing medium stands in front of the information terminal device 1, looks at the initial screen, and starts operation (S101).

Next, at S102, a display of urging reading of the radio IC chip 120 appears on the screen section 2, so that he makes the radio IC chip 120 approach or come in contact with the reader/writer section 4 (varies with the specification of the transmission and reception capacity of the radio IC chip 120 used, may transmit and receive in a state that it is stored in a pocket or a bag) and reads information (user information, balance information, etc.) in the radio IC chip 120 by the information terminal device 1.

If in confirmation of the reading operation of the radio IC chip 120 at S103, the user stops the operation, thus the chip 120 does not read (No), when the specified time elapses (S201), the printing means is instructed to return to the standby state (S202) and enters the standby state (S203). When the user has an intention to continue the operation at S201, he returns to the state at S102 and makes the radio IC chip 120 read data.

When an error is caused in the reading operation of the radio IC chip 120, he is, urged to re-read at S104, and when an error is caused even in the re-reading (Yes), error information is transmitted to the control computer (S301), and an error is displayed (S302). The operation is stopped (S303).

At S104, when the radio IC chip 120 is properly read and no error is caused (No), on the screen, user information is displayed on the basis of the information stored in the radio IC chip 120 (S105) and the necessary items such as confirmation and/or setting and changing are urged (S106). When setting and input are necessary, an appropriate operation is performed.

On the basis of a display of urging loading of the image storing medium on the medium reading section 3 (S107), the image storing medium is loaded.

When the image storing medium is not loaded within the specified time (S401), and the user stops the operation, thus the image storing medium is not loaded straight (Yes), the printing means is instructed to return to the standby state (S202) and enters the standby state (S203). At S401, when the image storing medium is loaded within the specified time (No), at S107, the display of urging loading of the image storing medium is continued.

In confirmation of an error of the loaded image storing medium (S109), when an error of defective reading is caused (Yes), error information is transmitted to the control computer (S501) and an error is displayed on the screen section 2 of the information terminal device 1 (S502). The operation is stopped (S503).

At S109, when the image storing medium is loaded properly and no reading error is caused (No), an image stored in the image storing medium is read and is displayed by an index on the screen section 2 (S110) and on the basis of display (S111) urging the various print designation operations (print setting operations) such as selection of an image, designation of the number of images, and designation of the size, the user designates an image to be printed and instructs various settings to the designated image.

In confirmation of completion of the print designation operation (print setting operation) (S112), as long as the fixed time (for example, 3 minutes) does not elapse (No at S601), the display urging the print designation operation (print setting operation) at S111 is continued and when the print designation operation (print setting operation) is performed after lapse of the fixed time (Yes at S601), at S602, the loading state of the image storing medium is confirmed. When the image storing medium is removed by the user and is not loaded already (No), the printing means is instructed to return to the standby state (S202) and enters the standby state (S203).

At S602, when the image storing medium is loaded (Yes), the state that although the user has no intention to continue the operation, the image storing medium is loaded is judged as forgetting of removal of the image storing medium, thus the forgetting of removal is notified at least to either of the user and control computer as a warning. Until a sales-clerk or a clerk in charge notified of forgetting of removal via the user or control computer becoming aware of forgetting of removal by the warning pulls out the image storing medium, the loading state of the image storing medium is confirmed at S602, and a warning is issued at S603. Further, the warning for the forgetting of removal will be described later.

At Step S112, when the print designation operation (print setting operation) is completed (Yes), at S113, settlement of accounts is displayed and display for urging settlement of accounts is outputted by the radio IC chip 120.

At S114, selection of whether to settle accounts for other than the radio IC chip 120 or not is urged, and another accounts settlement means can be selected (Yes), and when it is selected, settlement of accounts is performed in cash or by a credit card using the bending section 5 (S130), and the operation is continued to S118 described later.

When another accounts settlement means is not selected at S114 (No) and settlement of accounts by the radio IC chip 120 is decided, at S115, the radio IC chip 120 approaches or makes contact with the reader/writer section 4. Namely, when selection and setting of an image to be printed are completed (Yes at S112), as long as another accounts settlement means is not positively selected, by one operation of making the radio IC chip 120 come into contact with the reader/writer section 4, instruction of printing and settlement of accounts are completed, so that the operation is simple and not troublesome at all. Further, if transmission and reception are possible when the radio IC chip 120 is not in contact with the reader/writer section 4 and is stored in a pocket or a bag, by the button operation (one operation) of the user, instruction of printing and settlement of accounts are completed.

At S116, on the basis of the information (deposit balance, etc.) in the radio IC chip 120, whether settlement of accounts is possible or not is judged and when it is possible, the settlement of accounts is performed at S117. By the settlement of accounts, the information of settlement of accounts in the radio IC chip 120 is rewritten. The information of settlement of accounts is transmitted not only between the information terminal device 1 and the radio IC chip 120 but also to the control computer of the information terminal device 1 and is preferably controlled centralizedly by the head office. By doing this, even if the user loses the radio IC chip 120, it is backed up at ease and in safety.

If an error is caused when reading the information in the radio IC chip 120 or rewriting the information of settlement of accounts (Yes at S116), the image print designation operation is stopped and the images from the image storing medium which are read in the hard disk and RAM in the information terminal device 1 are erased (S901). Furthermore when reading the information in the radio IC chip 120 does not complete normally even if it elapses a predetermined time (Yes at S701), the image print designation operation is stopped and the images from the image storing medium which are read in the hard disk and RAM in the information terminal device 1 are erased (S702). When the operation is stopped, the user leaves the information terminal device. At this time, when various information of the user is erased, the secret of the user can be kept and a next user can start operation on a new screen, so that no trouble is given to him. As errors, (1) to (4) described below and/or other preset errors may be cited and when at least one error is caused, the print designation operation is stopped. (1) Lapse of the specified operation time (S701). (2) A reading or writing error from the radio IC chip 120 and/or the image storing medium (S115). (3) Insufficient balance in the radio IC chip 120 (S801). (4) other error for example incorrect use (S901).

(1) is for preventing one information terminal device from being exclusively occupied by one user unnecessarily for many hours. After lapse of the specified time (S701), the operation is stopped (S702). Thereafter, at S602, the forgetting of removal of the image storing medium is confirmed.

In (2), when the radio IC chip 120 cannot be read, the settlement of accounts is impossible.

When the insufficient balance in (3) occurs, if it can be confirmed to select another accounts settlement means (cash, credit card, etc.) at S801 and settle the accounts (Yes at S801), a constitution that unless the operation is stopped, the print designation operation is continued is used and the process at S118 is continued. When there is no settlement of accounts or no settlement of accounts is performed (No), the operation is stopped (S901). Error information is transmitted to the outside of the terminal device (S902), and an error is displayed (S903), and the operation is stopped (S904).

In incorrect use in (4), for example, when the radio IC chip 120 is to be reorganized, the operation is stopped immediately. Furthermore, a constitution that incorrect use information is transmitted to the control computer and is notified to a nearby sales-clerk or guard is preferable.

Further, when an error is caused during rewriting the information of settlement of accounts, a constitution that information of the error is transmitted and/or displayed and is notified to the outside of the information terminal device is preferable. Here, in this specification, “the outside of the information terminal device” indicates a sales-clerk or a clerk in charge of a store where the control computer or the concerned information terminal device is installed. The sales-clerk or clerk in charge preferably copes with the error immediately at site. At this time, if a constitution that the ID information of the user in which the error is caused is transmitted to the sales-clerk or clerk in charge is used, thorough coping with it is preferably facilitated more.

When settlement of accounts is possible, the accounts are settled (S117), and the image information is read from the image storing medium (S118), and images subject to various print designation operations are printed (S119). Further, a constitution that before the printing is started after the accounts are settled, the operation can be stopped and the information of settlement of accounts can be rewritten by designation by the user is included in the present embodiment.

After end of the printing, the image information read in the information terminal device 1 is erased (S120).

When the user finishes all the operations (S121) or stops the operations halfway or due to an error, at that point of time, he pulls out the image storing medium from the medium reading section 3 of the information terminal device 1 and finishes the operations.

Here, two kinds of cards such as the image storing medium and radio IC chip 120 are handled, so that there are possibilities of forgetting removal of the image storing medium loaded in the medium reading section 3 of the information terminal device 1. Therefore, it is preferable to give the constitution of preventing forgetting of removal (S602, S603) to the part where all the operations are finished (S121).

Namely, when a predetermined time elapses after end of the operation by the information terminal device 1 or the radio IC chip 120 is separated from the operation area of the information terminal device 1, if the image storing medium is kept loaded in the information terminal device 1, that is, the image storing medium is forgotten to remove, it is preferable to give the constitution of warning forgetting of removal to the user.

Here, when a detector for detecting existence of the user in the operation area of the information terminal detects that there is no user in the operation area, the control section generates a warning signal.

The warning of forgetting of removal may be a warning not only for the user but also for the outside of the information terminal device or for both. When the warning is for the user, the information terminal device 1 may produce a sound, a voice, and light and it may be a warning by broadcasting in a store or a warning on the information display screen in the store. When the warning is for the outside of the information terminal device, it is preferable to cope with it by warning a sales-clerk or a clerk in charge by the terminal device in charge or neighboring terminal device, notifying the user by the sales-clerk or clerk in charge, when the user cannot be caught, keeping it by the store, and notifying the user of it. By doing this, the image storing medium forgotten to remove can be prevented from being lost and from being passed to a third person.

When the warning is for the outside of the information terminal device, by use of a constitution that on the basis of the information of the radio IC chip 120 and/or image storing medium of the user forgetting to remove, the user information such as ID information is transmitted to the outside of the information terminal device, the user forgetting to remove can be identified, so that thorough coping by the sales-clerk or clerk in charge is preferably facilitated more.

The information terminal device of the present embodiment is explained above. Next, the image print system using the information terminal device of the present invention will be explained by referring to FIG. 5.

FIG. 5 is a layout drawing showing an embodiment of a store to which the image print system of the present invention is applied.

In the layout, the information terminal 1 is provided in the store.

The image print system of the present embodiment is structured so as to include the image storing medium, radio IC chip, and information terminal device which are described above and a gate.

The gate comprises radio IC chip 120, reader/writer section 71 which transmits and receives information, and a pair of photo sensors 72.

By the photo sensor pair, it distinguishes that a user is trying to go into the store, or that the user is going to come out from the store. When the user holds radio IC chip 120, reader/writer section 71 functions to read ID of IC chip 120 and to transmit ID to an administrative computer.

Moreover, the alarm 73 which constructs buzzers etc. is provided in the gate.

When the user has forgotten to take out an image storage medium which is mentioned later, the alarm 73 is formed so that an warning signal may sound.

Moreover, the administrative computer also always grasp the state of an information terminal unit.

For this reason, a management computer can work as a detection means to detect that the user came out of store area, having forgotten to take an image storage medium from the information terminal unit 1. Furthermore, when the problems above mentioned cause the management computer instructs the alarm 73 to sound a warning signal.

Further, “area” in this embodiment can be referred to as not only a store inside but also a specific corner in a store, a specific floor in a store having a plurality of floors, a corner developed store in a composite store, a corner developed store in a station yard or an underground shopping area, and a corner where a simple information terminal device is installed.

Furthermore, “possibility of coming out from the area or the situation” in this specification can be referred to as at the time of approaching the gate 7 to come out from the area, at the time of coming out, after coming out, and at the time of approaching the gate 7 when not intended to come out.

Furthermore, when the detecting mean detects a radio IC chip 120 in the operation area, the information terminal device 1 relating to the present embodiment has a constitution of optimizing a user interface (in the present invention, functions a screen section) of the information terminal device 1 according to the user on the basis of the ID information in the radio IC chip.

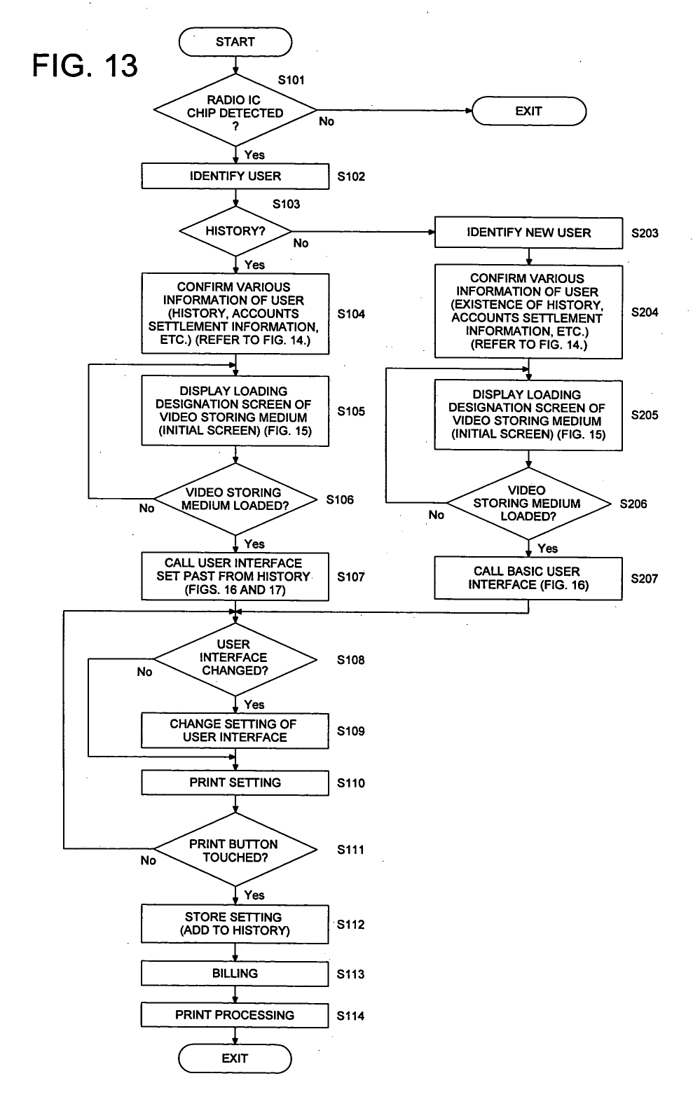

Namely, as shown in the flow chart in FIG. 13, when the user approaches the information terminal device 1, the reader/writer section 4 of the information terminal device 1 detects the radio IC chip carried by the user (Yes at S1101) and identifies a name of the user by verifying the ID information stored in the radio IC chip (S1102). An actual embodiment is explained detail with steps below.

By identification of the user and by the existence of the history of user (S1103), whether it is a repeater user or a new user is identified. The information to identify the user, on the basis of the ID information in the carried radio IC chip and the information of the user data base of the control computer, is confirmed (S1104, S1204).

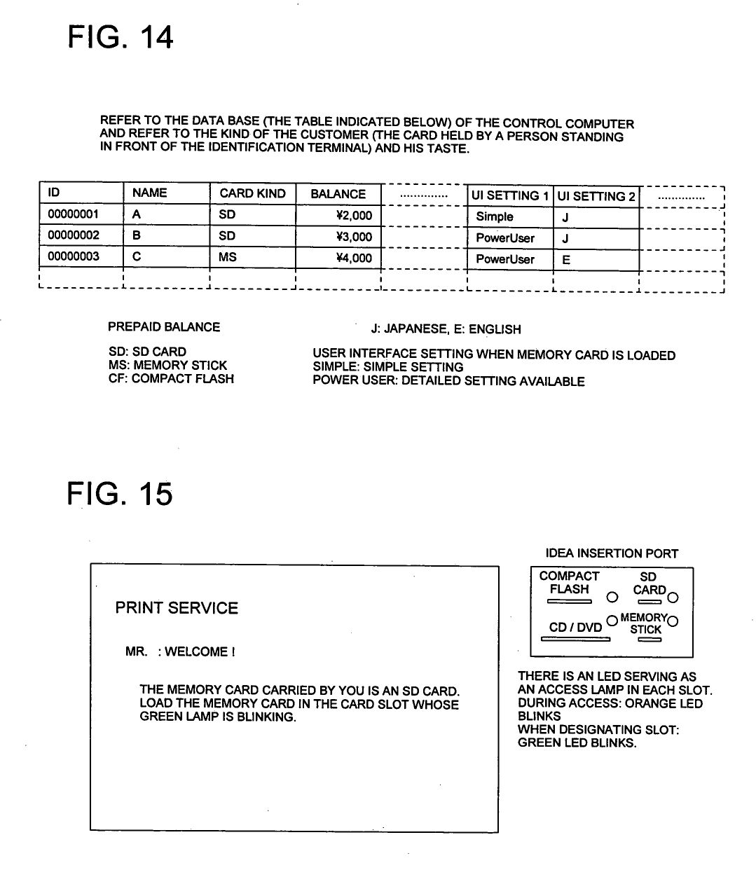

As shown in FIG. 14, in the user data base of the control computer, a plurality of user information is controlled. The item “ID” is an intrinsic number of an image storing medium 8 with a radio IC chip. The item “Name” is user information such as a name, and the item “Card kind” is the kind (standard) of the image storing medium to which the concerned ID is given, and SD indicates an SD card (registered trademark), and MS indicates a memory stick (registered trademark), and CF indicates a compact flash registered trademark). The item “UI setting 1” indicates setting of the user interface of the information terminal device 1 which will be described later and stores which one is selected by the user in the preceding terminal operation, simple setting (Simple) or detailed setting (Power User) which will be described later.

The item “Balance” indicates a balance according to the printing charge paid in advance.

The item “UI setting 2” similarly stores the setting of the user interface selected by the user in the preceding terminal operation, and J indicates Japanese, and E indicates English.

Similarly, although not drawn, there are the item “UI setting 3”, “UI Setting 4”, “UI setting 5”, and “UI Setting 6” and the items respectively store the settings of the user interface (Simple/Power User, J/E, Simple/Power User, J/E) two times before and three times before. With respect to the setting of the user interface based on the history, only the setting one time before may be simply used or the majority decision of the settings before one time, before two times, and before three times may be accepted.

Furthermore, similarly to the information stored in the radio IC chip, the past print history and the history relating to print setting are stored altogether.

And, these history information is stored in the control computer for each ID, and the control computer controls the whole, and individual information is also stored in the radio IC chip. Further, when the information terminal device 1 is used first, these items of “UI setting 3”, “UI Setting 4”, “UI setting 5”, and “UI Setting 6” is blank. These items is used for distinguish whether it is a new user or not.

Here, using the information of the user identified by the radio IC chip, the user interface of the information terminal device 1 is optimized. Namely, only when the user carries the radio IC chip and approaches the information terminal device 1, at the stage before starting the actual operation, the information terminal device 1 recognizes and identifies the user and the user interface optimized by the user, for example, the initial screen optimized by a specific user can be prepared.

The information of the user data base is linked with the information in the radio IC chip and is updated every use and information which cannot be stored (or is not stored) in the radio IC chip is also stored.

When there is a history at S1103, that is, it is identified that it is a repeater user, the past history is confirmed at S1104 and the initial screen (refer to FIG. 15) based on the history is displayed on the screen section 2 (S1105). At this time, the user is identified already, so that display of “Mr. So-and-so” on the screen section 2 is preferable emotionally on an operation basis in respect of user friendliness. Further, the kind (standard) of the image storing medium carried by the user is identified already (an SD card in this embodiment), so that it is preferable to display “The memory card carried by the customer is an SD card.” and confirm and recognize the kind (standard) of the image storing medium. When the image storing medium carried by the user is identified, the user interface can be optimized according to the kind (standard) of the image storing medium.

Loading of the image storing medium is urged at S1105 and by blinking the loading position of the SD card among several loading positions of the medium reading section 3, the correct loading position is instructed.

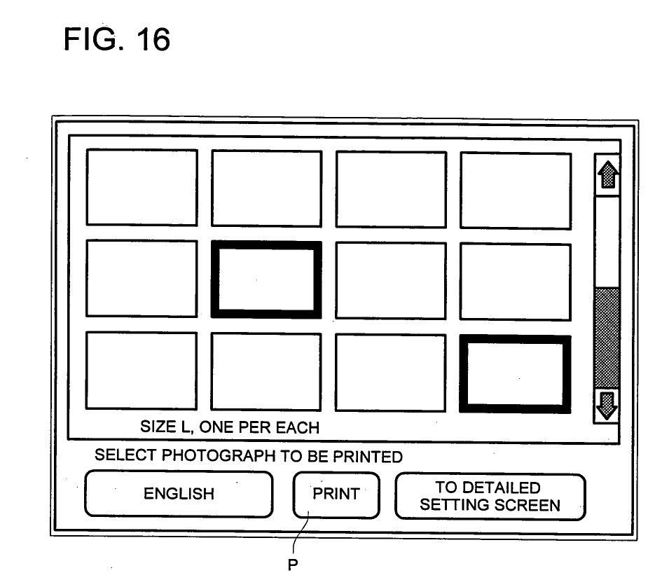

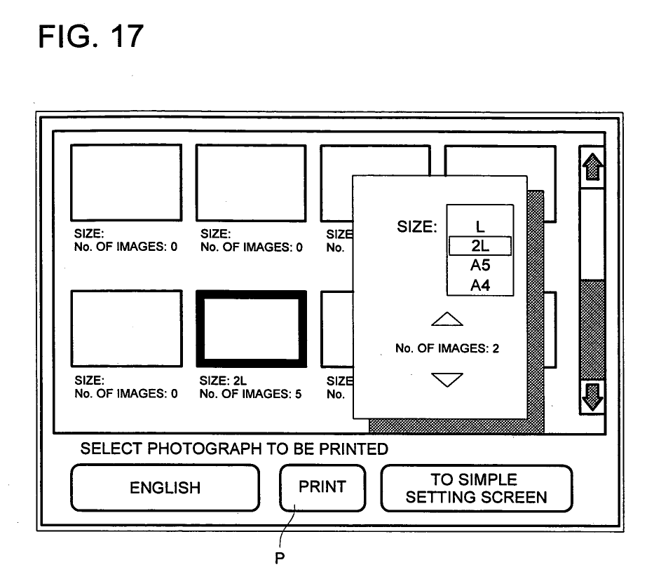

The loading of the image storing medium is confirmed at S1106, and the user interface based on the history is called at S1107, and the screen section 2 makes an optimal display according to the user. In this embodiment, Simple setting (FIG. 16) and Detailed setting (FIG. 17) are prepared. However, the present invention is not limited to the two kinds and various settings such as setting of the two mixed, more detailed setting, and simpler setting can be adopted. Further, the setting includes not only selection of easiness or complexity of the operation but also selection of language such as Japanese or Korean and selection of operation guidance by voice.

As an example of setting of Simple setting (FIG. 16), the setting of using the basic size L and printing each of selected frames may be cited as a default setting.

As an example of setting of Detailed setting (FIG. 17), setting that the pull-down menu and dialog are displayed for each selected frame, and not only the size and the number of print images can be individually set but also images can be edited (enlargement, contraction, partial separation, rotation, inversion, frame display, inversion display, monochromatic conversion display, sepia conversion display, text frame display, date inprint, etc.) may be cited. Particularly, existence or nonexistence of date inprint of Detailed setting is preferably automatic setting on the basis of the print setting history.

When the user interface may be in the same setting as the past setting based on the history at S1107 (S1108), the process goes to S1110 straight and the image to be printed is selected. Concretely, in FIGS. 16 and 17, when the index display part is touched, the frame to be printed can be selected. The selected frame becomes thick in the rim and can be discriminated.

When changing the user interface from the current one, Change can be selected (Yes) at S1108. Concretely, there is a button installed to transfer to the Detailed setting screen on the Simple setting screen shown in FIG. 16 and when the button is touched, the screen is transferred to the Detailed setting screen (FIG. 17) (S1109). Further, on the Detailed setting screen, there is a button for transferring to the Simple setting screen and when the button is touched, the screen is transferred to the Simple setting screen (S1109). On both screens, there are buttons for transferring to English expression and when the buttons are touched, the expression is switched to English expression (S1109).

The setting can be changed during display of the screen section 2 or during operation by displaying or arranging the button for selecting changing of the operation system of the information terminal device 1. When the setting is changed, the setting changing information (the operation history of the information terminal device 1) can be added to the history at S1112. The setting changing information and is used as information of the next and subsequent print designation operations. Therefore, the user interface customized only for the user is ready and accustomed every use, so that it can be operated familiarly.

The aforementioned is a case that there is a history (Yes) at S1103, that is, it is identified that he is a repeater user. However, when there is no history (No) at S1103, that is, it is identified that he is a new user (S1203), the user interface cannot be optimized on the basis of the past history, so that a basic user interface is set. When he is a new user, to make the user interface more friendly, in addition to display of characters on the screen section 2, guidance by voice may be added. Further, by blinking the lamp indicating the concerned position according to the operation, a constitution of leading the eyes of the user may be added. Further, it is preferable to set so as to cancel the voice or blinking by selection of the user.

Even if he is a new user, the user information is stored beforehand in the radio IC chip, so that on the basis of various kinds of information of the user (user information such as name, information of settlement of accounts, kind (standard) of the image storing medium, etc.) confirmed at S1204, the initial screen (refer to FIG. 15) is displayed on the screen section 2 (S1205). At this time, the user is identified already, so that display of “Mr. So-and-so” on the screen section 2 is preferable emotionally on an operation basis in respect of user friendliness. Further, the kind (standard) of the image storing medium carried by the user is identified already (an SD card in this embodiment), so that it is preferable to display “The memory card carried by the customer is an SD card.” and confirm and recognize the kind (standard) of the image storing medium.

Loading of the image storing medium is urged at S1205 and by blinking the loading position of the SD card among several loading positions of the medium reading section 3, the correct loading position is instructed. Since he is a new user, it is preferable to illustrate the loading method and loading direction by a diagram on the screen section 2.

The loading of the image storing medium is confirmed at S1206, and since he is a new user, the basic user interface is called at S1207, and the display of the screen section 2 is optimized according to the user. In this embodiment, as a basic user interface, Simple setting (FIG. 16) is displayed. Hereinafter, the process moves to S1108 and the aforementioned process is executed.

Even if he is a new user, when he has an experience of using this kind of information terminal device, is irritated at operation because the Simple setting is too simple, or requires the Detailed setting, he selects (Yes) Changing at S1108, changes the setting to the Detailed setting (for example, refer to FIG. 17), or selects the changing button of “To Detailed setting screen” displayed on the screen of the Simple setting (FIG. 16), thereby changes the setting during operation.

When the selection of the frame to be printed and setting of the print conditions are completed at S1110, the touching of the print button P, that is, the print start process by the user is detected at S1111.

When the print start instruction is detected (Yes at S1111), the setting of the user interface is stored and added to the history at S1112 and then the billing process is performed at S1113. This process is performed by decreasing the deposit balance of the radio IC chip adhered to the surface of the image storing medium according to a print order. Thereafter, at S1114, the actual print process is executed and when the print process is completed, the routine is finished.

According to the recording medium of the present invention explained above, the display section is installed at least one of the surface and back of the image storing medium, so that unlike a one having a built-in radio IC chip, a combination with the image storing medium and a design thereof are worked out easily, and the radio IC chip can be exchanged easily, and various data can be displayed easily.

Furthermore, when an adhesive layer is installed on the display section, the display section can be installed very easily on the image storing medium.

Further, according to the information terminal device of the present invention, settlement of accounts can be performed only by the print designation operation of the self print form and although two steps of the print designation operation and accounts settlement operation are conventionally required, the process can be finished by one step, thus the operability is improved.

Furthermore, a constitution that the information read in the information terminal device is erased when an error is caused is used, so that the secret of the user can be kept, and a next user can start operation on a new screen, so that no trouble is given to him.

Further, when a constitution that even when the balance is insufficient, settlement of accounts can be performed by another accounts settlement means is used, another accounts settlement means (cash or a credit card) is selected to settle the accounts and the print designation operation can be continued.

Further, when a constitution that when an error is caused at the time of settlement of accounts, error information is notified to the outside of the information terminal device is used, a sales-clerk or a clerk in charge can immediately cope with the error at site.

Even if the user may leave the place with the image storing medium loaded in the information terminal, though the operation is finished or the user may leave the place, though the operation is not finished, the sales-clerk or clerk in charge can respond to it.

Particularly, when a constitution that the user interface of the information terminal device is optimized on the basis of the information in the radio IC chip carried by the user is used, an information terminal device easy to operate is available for each user, so that the trouble accompanying the print designation operation such as a misoperation or a not-clear operation can be reduced remarkably. The information terminal device not only can be simply operated by a user using it first without being bewildered but also is easier to use by a repeater user.

Further, the image print system of the present invention has a constitution that when the user forgets to remove the image storing medium inserted in the information terminal device, it is notified to the user or the outside of the information terminal device, so that the image storing medium can be prevented from being lost and from being passed to a third person.

Particularly, the image print system of the present invention has a constitution that on the basis of the information of the radio IC chip of the user forgetting to remove and/or the image storing medium, the user information such as ID information is transmitted to the outside of the information terminal device, so that the user forgetting to remove can be identified, thus a sales-clerk or a clerk in charge can perform a thorough response more easily.

1. A recording medium comprising:
an image storing medium for storing an image information; and
a display section installed on a surface of said image storing medium,
wherein said display section includes a radio IC chip.

2. The recording medium according to claim 1, wherein said display section comprises:
a first base member;
an IC module including said radio IC chip and an antenna; and
a second base member, which are laminated in this order.

3. The recording medium according to claim 1, wherein said display section comprises:
a first base member;
an IC module including said radio IC chip and an antenna;
a second base member; and
an adhesive layer being detachable on said image storing medium, which are laminated in this order.

4. The recording medium according to claim 3, wherein a thickness of the image storing medium is not more than a thickness of a slot of an imaging apparatus in which the image storing medium is loaded.

5. The recording medium according to claim 1, wherein said image storing medium has a formed concavity having a depth of more than a thickness of said display section and an area of said display section on said image storing medium is smaller than an area of said concavity on said image storing medium.

6. The recording medium according to claim 1, wherein at least one of the first base member and the second base member includes a material being little shielding the electric field.

7. An information terminal device comprising:
a print designation operation section for conducting an image print designation operation,
a medium loading section for loading an image storing medium;
a medium reading section for reading image information stored in said image storing medium,
a reader-writer section for receiving information stored in a radio IC chip and transmitting information from said information terminal device, and
a control section for updating information of settlement of accounts received from said radio IC chip on the basis of information generated according to said print designation operation and for transmitting said updated information of settlement of accounts to said radio IC chip by said reader-writer section.

8. The information terminal device according to claim 7, further comprising:
a transmission device for transmitting said updated information of settlement of accounts to an outside of said information terminal device.

9. The information terminal device according to claim 7, further comprising:
a display section for displaying information according to an operation of said control section,
wherein said control section, when updating said information of settlement of accounts, on the basis of at least one error information of (1) to (4) indicated below, displays the error information on said display section,
stops said image print designation operation of said print designation operation section, and
erases said image information read by said medium reading section,
(1) error information indicating a lapse of a specified operation time,
(2) reading error information from said radio IC chip and/or said image storing medium,
(3) insufficient balance error information in said radio IC chip, and
(4) incorrect use error information.

10. The information terminal device according to claim 9, wherein said control section, on the basis of said insufficient balance error information in said radio IC chip in (3), displays an accounts settlement means selection screen on said display section.

11. The information terminal device according to claim 9, further comprising:
a transmission device for transmitting said error information to an outside of said information terminal device.

12. The information terminal device according to claim 7, wherein said control section, when a time of said image storing medium being loaded in said medium loading section or a time of said designation operation being conducted by said print designation operation section elapses a predetermined time, generates a warning signal.

13. The information terminal device according to claim 7, further comprising:
a detector for detecting existence of a user in an operation area of said information terminal device,
wherein said control section, when said image storing medium is loaded in said medium loading section and said detector detects that no user exists in said operation area, generates a warning signal.

14. The information terminal device according to claim 12, further comprising:
a transmission device for transmitting information according to said warning signal to an outside of said information terminal device.

15. The information terminal device according to claim 7, further comprising:
a screen section having a display section for displaying information according to operations of said print designation operation section and said control section,
wherein said reader-writer section detects existence of said radio IC chip in said operation area of said information terminal device and displays an optimized screen based on said information received from said radio IC chip on said screen section.

16. The information terminal device according to claim 15, wherein said optimized screen is an initial screen before said image storing medium is loaded in said medium loading section.

17. The information terminal device according to claim 15, wherein said reader-writer section displays said optimized screen based on operation history information of said information terminal device received from said radio IC chip or an image print designation operation history on said screen section.

18. The information terminal device according to claim 15, wherein said reader-writer section displays said optimized screen based on a kind of said image storing medium received from said radio IC chip on said screen section.

19. An image print system comprising:
an image storing medium containing image information;
a radio IC chip containing information other than said image information;
an information terminal device including a medium loading section for loading said image storing medium, a medium reading section for reading image information stored in said image storing medium, a print designation operation section for performing an image print designation operation on the basis of said read image information, a reader-writer section for receiving information stored in said radio IC chip and transmitting information from said information terminal device, and a transmitter for transmitting information to an outside of said information terminal device, and a control section for controlling said print designation operation section, said medium loading section, said medium reading section, and said reader-writer section; and
a detection section for detecting existence of said radio IC chip in said operation area of said information terminal; and
a detection information transmission section for transmitting said detection information obtained by said detector to said information terminal,
wherein said control section, when said image storing medium is loaded in said medium loading section and no existence of said radio IC chip in said operation area is detected on the basis of said detection information, generates a warning signal.

20. The image print system according to claim 19, wherein said information terminal further comprises:
a transmitter for transmitting information according to said warning signal to said outside of said information terminal device.
